(19) United States
(12) Patent Application Publication
(10) Pub. No.: US 2025/0187940 A1
(43) Pub. Date: Jun. 12, 2025

(54) METHOD FOR MANUFACTURING CONDUCTIVE OXIDE FOR MEMBRANE-ELECTRODE ASSEMBLY AND MEMBRANE-ELECTRODE ASSEMBLY

(71) Applicant: SAMSUNG ELECTRO-MECHANICS CO., LTD., Suwon-si (KR)

(72) Inventors: Hae Sol JUNG, Suwon-si (KR); Byung Chul JANG, Suwon-si (KR); Tae Jun CHOI, Suwon-si (KR); Guh Hwan LIM, Suwon-si (KR); Sun Il JEONG, Suwon-si (KR)

(73) Assignee: SAMSUNG ELECTRO-MECHANICS CO., LTD., Suwon-si (KR)

(21) Appl. No.: 18/952,857

(22) Filed: Nov. 19, 2024

(30) Foreign Application Priority Data
Dec. 6, 2023 (KR) 10-2023-0175062

(51) Int. Cl. C01G 23/08; H01M 4/62

(52) U.S. Cl. CPC C01G 23/08; H01M 4/624; C01P 2006/40

(57) ABSTRACT

A method for manufacturing a conductive oxide for a membrane-electrode assembly includes heat-treating a metal oxide and cooling the metal oxide, wherein a cooling rate in cooling the metal oxide is at least twice a heating rate in the heat-treating the metal oxide, based on an absolute value.

### CROSS-REFERENCE TO RELATED APPLICATION(S)

This application claims the benefit of priority to Korean Patent Application No. 10-2023-0175062 filed on Dec. 6, 2023 in the Korean Intellectual Property Office, the disclosure of which is incorporated herein by reference in its entirety.

### TECHNICAL FIELD

The present disclosure relates to a method for manufacturing a conductive oxide for a membrane-electrode assembly.

### BACKGROUND

Polymer electrolyte membrane fuel cells and polymer electrolyte membrane water electrolysis cells are eco-friendly energy source devices using hydrogen and have come to prominence due to the high efficiency and ease of miniaturization. Polymer electrolyte membrane fuel cells and polymer electrolyte membrane water electrolysis cells generally include a membrane-electrode assembly (MEA) in which a polymer electrolyte membrane is disposed between catalyst electrodes, and the performance of the membrane-electrode assembly significantly affects the performance of the fuel cells or the water electrolysis cells.

Among the components of such a membrane-electrode assembly, the catalyst electrode may generally include a material and an ion conductor, and here, the catalyst catalyst material may be used in a form supported on a support. When a support is included in the catalyst electrode, materials that may be used as the support may be limited in order to withstand an acidic environment and the like, and metal oxides may be used as the support. However, metal oxide supports do not have high electrical conductivity, so they may negatively affect the performance of the membrane-electrode assembly.

### SUMMARY

An aspect of the present disclosure is to implement an effective manufacturing method for obtaining a conductive oxide for a membrane-electrode assembly having excellent electrical conductivity. However, the object of the present disclosure is not limited to the aforementioned object and is realized by units and combinations thereof described in the claims.

According to an aspect of the present disclosure, a method for manufacturing a conductive oxide for a membrane-electrode assembly includes: heat-treating a metal oxide; and cooling the metal oxide, wherein a cooling rate in cooling the metal oxide is at least twice a heating rate in the heat-treating the metal oxide, based on an absolute value.

The metal oxide may include at least one of TiO₂, SnO₂, antimony tin oxide (ATO), indium tin oxide (ITO), and fluorine doped tin oxide (FTO).

A temperature for heat-treating the metal oxide may be 300° C. to 1000° C.

The method may further include mixing the metal oxide with a reducing agent during or before heat-treating the metal oxide.

The heat-treating the metal oxide may be performed under a gas atmosphere of at least one of Ar, N₂, H₂, and He.

After cooling the metal oxide, electrical conductivity of the metal oxide may be 10⁻² S/m to 10⁵ S/m.

Electrical conductivity of the metal oxide after the cooling of the metal oxide may be 1/100 or more of electrical conductivity of the metal oxide before the cooling after the heat treatment.

The metal oxide may include tetragonal TiO₂ before the heat treatment, and the conductive oxide may include monoclinic TiO₂ and orthorhombic TiO₂.

The metal oxide may include TiO₂ in a tetragonal phase before the heat treatment, and the conductive oxide may include TiₓO_{y} (y/x<2).

The TiₓO_{y} (y/x<2) may include at least one of TiO, Ti₂O₃, Ti₃O₅, Ti₄O₇, Ti₅O₉, Ti₆O₁₁, and Ti₈O₁₅.

The cooling rate in the cooling of the metal oxide may be 10 times more and less than 40 times compared to the heating rate in the heat-treating the metal oxide, based on an absolute value.

The cooling of the metal oxide may be performed at a rate of 5° C./min. to 500° C./min.

The cooling of the metal oxide may be performed at a rate of 20° C./min. to 100° C./min.

The membrane-electrode assembly may include a catalyst support, and the catalyst support may include the conductive oxide.

The membrane-electrode assembly may include a gas diffusion layer, and the conductive oxide may coat a surface of the gas diffusion layer.

According to another aspect of the present disclosure, a method for manufacturing a conductive oxide for a membrane-electrode assembly includes: heat-treating a metal oxide;

and cooling the metal oxide, wherein the cooling of the metal oxide is performed at a rate of 5° C./min. to 500° C./min.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a flowchart illustrating a process of a method for manufacturing a conductive oxide for a membrane-electrode assembly according to an exemplary embodiment in the present disclosure;

FIG. 2 illustrates process temperature and electrical conductivity of metal oxide over time during a heating and cooling process in the related art;

FIG. 3 illustrates process temperature and electrical conductivity of metal oxide over time during a heating and cooling process in an exemplary embodiment in the present disclosure;

FIG. 4 is a cross-sectional view illustrating an example of a catalyst and a support for a membrane-electrode assembly;

FIG. 5 is a cross-sectional view schematically illustrating a membrane-electrode assembly according to an exemplary embodiment in the present disclosure;

FIG. 6 is an enlarged view of components of a membrane-electrode assembly;

FIG. 7 illustrates a membrane-electrode assembly according to a modified example; and

FIG. 8 is an enlarged view of a region of a gas diffusion layer in the membrane-electrode assembly of FIG. 7.

### DETAILED DESCRIPTION

Hereinafter, exemplary embodiments of the present inventive concept will be described in detail with reference to the accompanying drawings. The inventive concept may, however, be exemplified in many different forms and should not be construed as being limited to the specific exemplary embodiments set forth herein. Rather, these exemplary embodiments are provided so that this disclosure will be thorough and complete, and will fully convey the scope of the inventive concept to those skilled in the art. In the drawings, the shapes and dimensions of elements may be exaggerated for clarity, and the same reference numerals will be used throughout to designate the same like elements.

To clarify present the disclosure, portions irrespective of description are omitted and like numbers refer to like elements throughout the specification, and in the drawings, the thickness of layers, films, panels, regions, etc., are exaggerated for clarity. Also, in the drawings, like reference numerals refer to like elements although they are illustrated in different drawings. Throughout the specification, unless explicitly described to the contrary, the word “comprise” and variations, such as “comprises” or “comprising,” will be understood to imply the inclusion of stated elements but not the exclusion of any other elements.

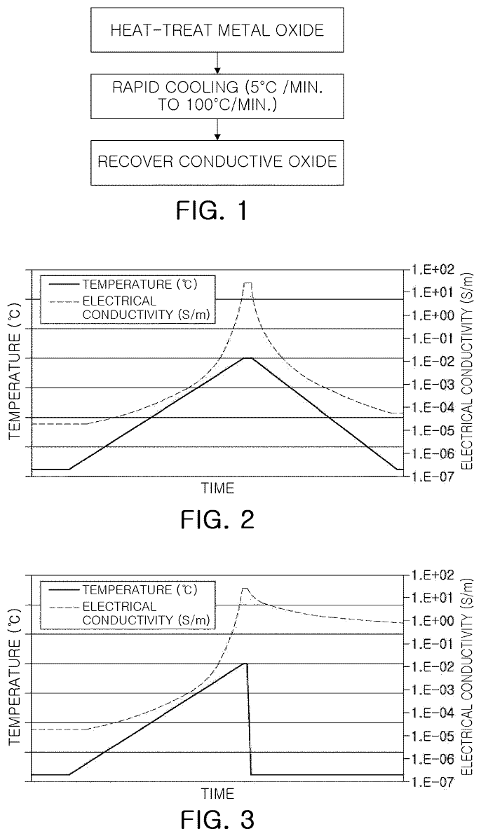

FIG. 1 is flowchart illustrating a process of a method for manufacturing a conductive oxide for a membrane-electrode assembly according (MEA) to an exemplary embodiment in the present disclosure. In the method for manufacturing a conductive oxide for an MEA according to the present exemplary embodiment, metal oxide is reduced by a heat treatment at high temperatures and then cooled at a high rate to maintain electrical conductivity of the metal oxide at a high level, and when the metal oxide is applied to a electrode of an MEA, deterioration of electrical performance in the MEA may be prevented.

Specifically, the method for manufacturing a conductive oxide for an MEA according to the present exemplary embodiment includes heat-treating a metal oxide and cooling the metal oxide, wherein a cooling rate in the operation of cooling the metal oxide is twice or more based on an absolute value than a heating rate in the operation of heat-treating the metal oxide. After cooling the metal oxide, the conductive oxide may be recovered by an appropriate method. In the present exemplary embodiment, the manufactured conductive oxide may have a high level of oxidation resistance and conductivity to be appropriately used as a catalyst support. However, in addition to this, the conductive oxide may also be used in other components constituting the MEA, for example, in a coating material of a gas diffusion layer of FIG. 8.

The metal oxide may correspond to a precursor for obtaining a conductive oxide that may be used as a catalyst support and the like, and materials applicable to the catalyst support and the like in the catalyst electrode of the MEA may be used. For example, the metal oxide may include at least one of TiO₂, SnO₂, antimony tin oxide (ATO), indium tin oxide (ITO), and fluorine doped tin oxide (FTO). In addition, the metal oxide may be provided in any form capable of manufacturing a catalyst support. For example, the metal oxide may be provided in powder form.

In the operation of heat-treating the metal oxide, the electrical conductivity of the metal oxide may be improved by changing a phase of the metal oxide or reducing the metal oxide. In this case, the heat treatment for the metal oxide is preferably performed at a relatively high temperature. For example, the heat treatment temperature may be 300° C. to 1000° C. In the heating operation for heat treatment, a slope of the temperature may be maintained constant. The method may further include an operation of mixing the metal oxide and a reducing agent during or before the operation of heat-treating the metal oxide. The reducing agent may be a material capable of reducing the amount of oxygen in the metal oxide and may include, for example, at least one of NaBH₄, ascorbic acid, and hydrazine. In addition, the operation of heat-treating the metal oxide may be performed under a gas atmosphere of at least one of Ar, N₂, H₂, and He, and accordingly, a reduction reaction of the metal oxide may be further promoted. As a specific example, the reaction atmosphere in the heat treatment operation may be maintained as a low-pressure gas atmosphere, and after maintaining vacuum (P≤10⁻³ torr), Ar gas of 1 torr or less may be injected.

Thereafter, the metal oxide is cooled, and then the conductive oxide is recovered and obtained. In the present exemplary embodiment, the metal oxide is cooled at a relatively high rate after the heat treatment operation to reduce a decrease in electrical conductivity as much as possible. That is, according to research by the inventors of the present disclosure, it was discovered that when heat-treated metal oxide is cooled at a rate faster than twice the heating rate, the electrical conductivity of the metal oxide remains high even at room temperature after cooling. In addition, even when the metal oxide was cooled at a rate of 5° C./min. to 500° C./min. even without considering the heating rate, the electrical conductivity of the metal oxide was able to be maintained high at room temperature after cooling. This will be described in more detail with reference to the graphs in FIGS. 2 and 3. FIGS. 2 and 3 illustrate a process temperature and electrical conductivity of metal oxide over time during a heating and cooling process. FIG. 2 corresponds to the related art without rapid cooling, and FIG. 3 corresponds to the present exemplary embodiment. Referring to the graph of FIG. 2, it can be seen that, when the cooling rate is similar to the heating rate during heat treatment, the electrical conductivity of the metal oxide after cooling falls to a level similar to that before heat treatment. This reduced electrical conductivity is at the level of 10⁻⁶ S/m to 10⁻² S/m, and an MEA using a catalyst support having low electrical conductivity has the problem of significantly reduced electrical properties.

In contrast, referring to the graph of FIG. 3, when the cooling rate of the metal oxide is significantly increased as in the present exemplary embodiment, the electrical conductivity of the metal oxide is at a high level, for example, at the level of 10⁻² S/m to 10⁵ S/m even if maintained at room temperature. Therefore, the MEA using the catalyst support having high electrical conductivity may have improved electrical properties, which may lead to improved performance of fuel cells or water electrolysis cells. As a more specific example, as can be seen from the graph of FIG. 3, the electrical conductivity of the metal oxide after the cooling operation may be 1/100 or more of the electrical conductivity of the metal oxide before the cooling operation after the heat treatment operation. However, the fact that the oxide has conductivity may include a case in which the oxide has an electrical conductivity of a level higher than that of the metal oxide before heat treatment, more specifically, 10⁻³ S/m, a level of about 10 times higher, even if it does not have the aforementioned high conductivity range.

Meanwhile, as the cooling rate of the metal oxide increases, the decrease in electrical conductivity may become less, thereby increasing the electrical conductivity of the catalyst support. From this point of view, the cooling rate of the operation of cooling the metal oxide may be 10 times or more and less than 40 times based on an absolute value compared to the heating rate in the operation of heat-treating the metal oxide. In addition, in the case of cooling rates rather than relative comparisons of heating rates, as described above, the operation of cooling the metal oxide may be performed at a rate of 5° C./min. to 500° C./min. More preferably, the operation of cooling the metal oxide may be performed at a rate of 20° C./min. to 100° C./min.

The reason why the electrical conductivity of the metal oxide is maintained high by the cooling process described above is understood as because a highly conductive crystal structure or phase generated by heat treatment is maintained even after cooling by suppressing additional reactions, such as reoxidation, that may occur during a temperature change process. For example, the metal oxide may include tetragonal TiO₂ before the heat treatment, and the catalyst support may include monoclinic TiO₂ or orthorhombic TiO₂. In addition, the metal oxide may include TiO₂ in a tetragonal phase before the heat treatment, and the catalyst support may include TiₓO_{y} (y/x<2). In this case, TiₓO_{y} (y/x<2) may include at least one of TiO, Ti₂O₃, Ti₃O₅, Ti₄O₇, Ti₅O₉, Ti₆O₁₁, and Ti₈O₁₅.

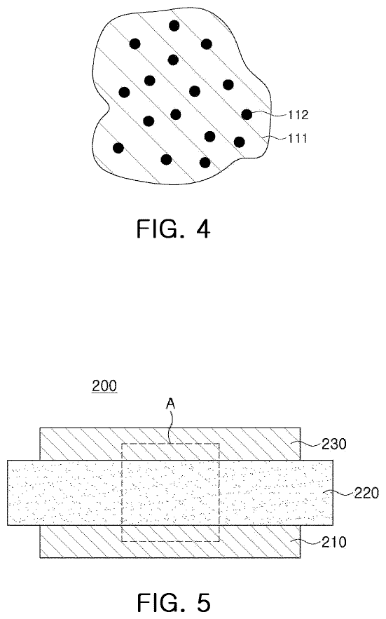

After the cooling operation, the conductive oxide may be subjected to an appropriate washing and recovery process, thereby obtaining a conductive oxide that may be used in a catalyst support for an MEA. FIG. 4 is a cross-sectional view illustrating an example of a catalyst support using the conductive oxide obtained through the process and a catalyst supported thereon. Referring to FIG. 4, by forming a catalyst 112 on a surface of the support 111 obtained through the manufacturing method described above, it may be used as a catalyst electrode in fuel cells, water electrolysis cells, and the like, which will be described below.

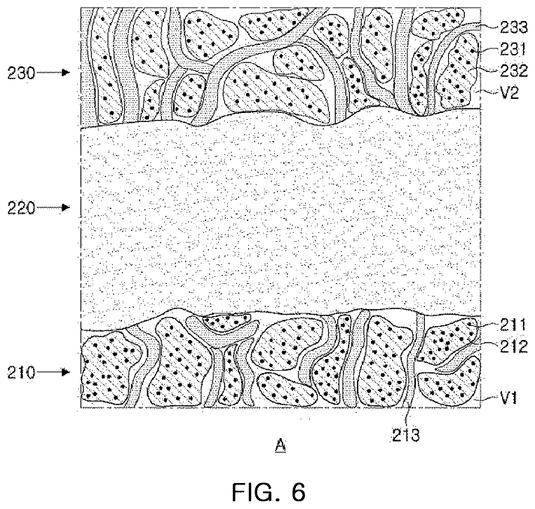

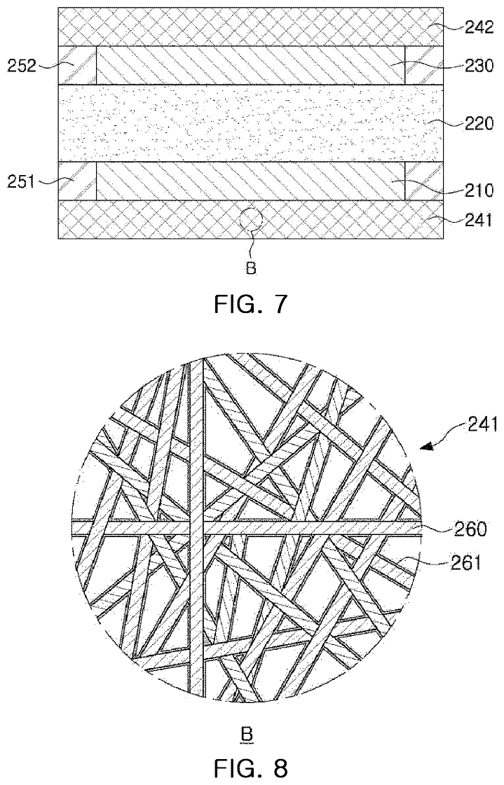

FIG. 5 is a cross-sectional view schematically illustrating an MEA according to an exemplary embodiment in the present disclosure, and FIG. 6 is an enlarged view of components of the MEA. Also, FIG. 7 illustrates an MEA according to a modified example, and FIG. 8 is an enlarged view of a region of a gas diffusion layer in the MEA of FIG. 7.

Referring to FIGS. 5 and 6, an MEA 200 according to an exemplary embodiment in the present disclosure includes a first catalyst electrode 210, a polymer electrolyte membrane 220, and a second catalyst electrode 230 as main components. Hereinafter, the components of the MEA 200 will be described in detail, focusing on a case in which the MEA 200 is a water electrolysis battery. However, the MEA 200 may be used as a fuel cell, in which case a reaction opposite to that of a case in which the MEA 200 is used as a water electrolysis cell may take place in the first catalyst electrode 210 and the second catalyst electrode 230 of the MEA 200.

The first catalyst electrode 210 may include a first catalyst 211 and a first support 212, in which the first support 212 may be implemented to have high electrical conductivity using the manufacturing method described above. In addition, the first catalyst electrode 210 may include an ion conductor 213, and the ion conductor 213 may function as a binder for the first catalyst 211. In addition, pores V1 may be formed within the first catalyst electrode 210 to allow gas, liquid, etc. to move smoothly. The first catalyst 211 is active in an oxygen generating reaction and may include an Ir-based, Ru-based, or Ti-based material. The ion conductor 213 may provide a migration path for hydrogen ions generated in the first catalyst electrode 210, and may include, for example, a fluorine-based ionomer, a carbon-hydrogen-based ionomer, or a mixture thereof. As a specific example, the ion conductor 213 may include a perfluorinated sulfonic acid ionomer. In the case of a water electrolysis cell, the first catalyst electrode 210 may be an anode, and water supplied thereto may be separated into oxygen (O₂), hydrogen ions (H+, protons), and electrons (electrons). Here, hydrogen ions may move to the second catalyst electrode 230 through the polymer electrolyte membrane 220, and the electrons may move to the second catalyst electrode 230 through an external circuit and a power supply.

The polymer electrolyte membrane 220 may include an ion conductor to provide a migration path for hydrogen ions, etc. Here, the ion conductor of the polymer electrolyte membrane 220 may include, for example, a fluorine-based ionomer, carbon-hydrogen-based ionomer, or a mixture thereof. As a specific example, the ion conductor 213 may include a perfluorinated sulfonic acid ionomer. In the case of a water electrolysis cell, hydrogen ions generated in the first catalyst electrode 210 may move to the second catalyst electrode 230 through the polymer electrolyte membrane 220.

The second catalyst electrode 230 includes a second catalyst 231 and is disposed on the polymer electrolyte membrane 220. In this case, the second catalyst 231 may be provided in a form supported on the second support 232, as illustrated in FIG. 6. In addition, the second catalyst electrode 230 may include an ion conductor 233, and the ion conductor 233 may function as a binder for the second catalyst 231 and the second support 232. In addition, pores V2 may be formed within the second catalyst electrode 230 so that gas, liquid, etc. may move smoothly. The second catalyst 231 may be active in a hydrogen oxidation reaction or oxygen reduction reaction and may include platinum (Pt), gold (Au), ruthenium (Ru), osmium (Os), palladium (Pd), and alloys thereof. The ion conductor 233 may provide a migration path for hydrogen ions, etc. and may include, for example, a fluorine-based ionomer, a carbon-hydrogen-based ionomer, or a mixture thereof. As a specific example, the ion conductor 233 may include a perfluorinated sulfonic acid ionomer. The second support 232 may be formed of a porous material having a high surface area to support a large amount of second catalysts 231. For example, a carbon-based support may be used. In the case of a water electrolysis cell, the second catalyst electrode 230 is a cathode, and hydrogen ions supplied through the polymer electrolyte membrane 220 may react with electrons to generate hydrogen.

Meanwhile, in the above description, a case in which the first catalyst electrode 210 and the second catalyst electrode 230 are an anode and a cathode, respectively, is used as an example, but the opposite structure may also be used. That is, as a modified example, in the MEA 200, the first catalyst electrode 210 may be a cathode and the second catalyst electrode 230 may be an anode.

Thereafter, in the case of the modified example of FIG. 7, gas diffusion layers 241 and 242 are further provided outside the catalyst electrodes 210 and 230, and FIG. 8 illustrates an enlarged view of a region of the gas diffusion layer. Specifically, a first gas diffusion layer 241 disposed below the first catalyst electrode 210 and a second gas diffusion layer 242 disposed above the second catalyst electrode 230 are further provided. These gas diffusion layers 241 and 242 may be implemented as porous transport layers (PTL), and preferably have a form that is excellent in durability and efficiency even at high current operating density. The gas diffusion layers 241 and 242 may serve to discharge oxygen bubbles within a stack of the water electrolysis cell, facilitate electrolyte penetration into an electrode surface, and conduct electricity between an electrode and a separator plate. In order to perform this function, as an example, the first gas diffusion layer 241 may include fiber 260 based on materials, such as titanium (Ti), and in addition, the first gas diffusion layer 241 may be implemented in the form of felt, mesh, sintered powder, and the like. A coating layer 261 may be formed on a surface of the first gas diffusion layer 241, in which the coating layer 261 may be formed using a conductive oxide obtained by the manufacturing method described above. As a result, the coating layer 261 may have a high level of oxidation resistance and electrical conductivity. As an example, the second gas diffusion layer 241 may be implemented using carbon fiber and may have a shape similar to that of the first gas diffusion layer 241.

A first spacer 251 may be disposed between the polymer electrolyte membrane 220 and the first gas diffusion layer 241 to surround the first catalyst electrode 210, and a second spacer 252 may be disposed between the polymer electrolyte membrane 220 and the second gas diffusion layer 242 to surround the second catalyst electrode 230. The first and second spacers 251 and 252 may function as gaskets preventing leakage of gas and the like and may be formed using polymer materials that may be used in the art.

In the case of the method for manufacturing a conductive oxide for an MEA according to an example of the present disclosure, the electrical conductivity of the obtained conductive oxide may be maintained at a high level. Therefore, when the conductive oxide is applied to catalyst supports, etc., the performance of fuel cells or water electrolysis cells may be improved.

While exemplary embodiments have been illustrated and described above, it will be apparent to those skilled in the art that modifications and variations could be made without departing from the scope of the present disclosure as defined by the appended claims.

What is claimed is:

1. A method for manufacturing a conductive oxide for a membrane-electrode assembly, the method comprising:
heat-treating a metal oxide; and
cooling the metal oxide,
wherein a cooling rate in cooling the metal oxide is at least twice a heating rate in the heat-treating the metal oxide, based on an absolute value.

2. The method for claim 1, wherein the metal oxide includes at least one of TiO₂, SnO₂, antimony tin oxide (ATO), indium tin oxide (ITO), and fluorine doped tin oxide (FTO).

3. The method for claim 1, wherein a temperature for heat-treating the metal oxide is in a range from 300° C. to 1000° C.

4. The method for claim 1, further comprising mixing the metal oxide with a reducing agent during or before heat-treating the metal oxide.

5. The method for claim 1, wherein the heat-treating the metal oxide is performed under a gas atmosphere of at least one of Ar, N₂, H₂, and He.

6. The method for claim 1, wherein, after cooling the metal oxide, electrical conductivity of the metal oxide is 10⁻² S/m to 10⁵ S/m.

7. The method for claim 1, wherein electrical conductivity of the metal oxide after the cooling of the metal oxide is 1/100 or more of electrical conductivity of the metal oxide before the cooling after heat-treating the metal oxide.

8. The method for claim 1, wherein
the metal oxide includes tetragonal TiO₂ before heat-treating the metal oxide, and
the conductive oxide includes monoclinic TiO₂ and orthorhombic TiO₂.

9. The method for claim 1, wherein
the metal oxide includes TiO₂ in a tetragonal phase before heat-treating the metal oxide, and
the conductive oxide includes TiₓO_{y} (y/x<2).

10. The method for claim 9, wherein the TiₓO_{y} (y/x<2) includes at least one of TiO, Ti₂O₃, Ti₃O₅, Ti₄O₇, Ti₅O₉, Ti₆O₁₁, and Ti₈O₁₅.

11. The method for claim 1, wherein the cooling rate in the cooling of the metal oxide is at least 10 times more and less than 40 times compared to the heating rate in the heat-treating the metal oxide, based on an absolute value.

12. The method for claim 1, wherein the cooling of the metal oxide is performed at a rate in a range from 5° C./min. to 500° C./min.

13. The method for claim 1, wherein the cooling of the metal oxide is performed at a rate in a range from 20° C./min. to 100° C./min.

14. The method for claim 1, wherein
the membrane-electrode assembly includes a catalyst support, and
the catalyst support includes the conductive oxide.

15. The method for claim 1, wherein
the membrane-electrode assembly includes a gas diffusion layer, and
the conductive oxide coats a surface of the gas diffusion layer.

16. A method for manufacturing a conductive oxide for a membrane-electrode assembly, the method comprising:
heat-treating a metal oxide; and
cooling the metal oxide,
wherein the cooling of the metal oxide is performed at a rate in a range from 5° C./min. to 500° C./min.

17. A membrane-electrode assembly, comprising:
a catalyst support including a conductive oxide manufactured using a method comprising:
heat-treating a metal oxide; and
cooling the metal oxide at a cooling rate that is at least two times in absolute value than a heating rate during the heat-treating of the metal oxide,
wherein the conductive oxide has an electrical conductivity in a range from 10⁻² S/m to 10⁵ S/m.

18. The membrane-electrode assembly of claim 17, further comprising a gas diffusion layer having a surface coated with the conductive oxide.

19. The membrane-electrode assembly of claim 17, wherein the metal oxide is selected from the group consisting of TiO₂, SnO₂, antimony tin oxide (ATO), indium tin oxide (ITO), fluorine doped tin oxide (FTO), and a combination thereof.

20. The membrane-electrode assembly of claim 17, wherein the cooling rate is in a range from 5° C./min. to 500° C./min.

21. The membrane-electrode assembly of claim 17, wherein the heat-treating is performed in a reducing environment.

22. The membrane-electrode assembly of claim 17, wherein the cooling rate is in a range from 10 to 40 times greater than the heating rate.

23. The membrane-electrode assembly of claim 17, wherein a ratio of conductivity of the metal oxide measured following the cooling to conductivity of the metal oxide measured after heat-treating is greater than or equal to 1/100.
